(19) United States
(12) Patent Application Publication
(10) Pub. No.: US 2013/0126446 A1
(43) Pub. Date: May 23, 2013

(54) Restrictor Guard

(71) Applicant: Michael A. Kozar, Lombard, IL (US)

(72) Inventor: Michael A. Kozar, Lombard, IL (US)

(21) Appl. No.: 13/299,002

(22) Filed: Nov. 17, 2011

(51) Int. Cl. B01D 37/00; B01D 35/00

(52) U.S. Cl. 210/767; 210/232

(57) ABSTRACT

A cone shaped grating that filters out large floating debris from entering or blocking a restrictor pipe in a catch basin and allows for the free flow of water through the restrictor when buoyant items enter the catch basin.

### BACKGROUND

1. Field of the Invention

This disclosure is related to the field of debris guards for flow restrictors and discharge or outflow pipes in catch basins. Specifically, the present disclosure is concerned with a device that can be affixed over the opening of a flow restrictor or discharge pipe in a catch basin, thereby reducing the incidence of debris clogging or frustrating the functioning of the flow restrictor or discharge pipe.

2. Description of the Related Art

Effective management of storm water runoff has been an issue ever since humans started living in concentrated settings and began to alter the natural environment around them. Before the development of human structures and cities, most rainfall soaked into the ground and either contributed to groundwater recharge or was recycled into the atmosphere by vegetation through evaporation. Modern human development and the impervious surfaces associated therewith (e.g., parking lots, roads, buildings, compacted soil) do not allow rain to infiltrate into the ground and, thus, more run-off is generated than is present in natural drainage systems. This additional run-off can cause detrimental flooding and erosion issues.

Storm sewer systems which collect water run-off from impervious surfaces are used to combat these problems and ensure that water is efficiently conveyed to waterways through pipe networks. During a rain or snow melt event, water run-off from streets, roofs, sump pumps and other hard surfaces enters the storm sewer system through an inlet and is conveyed through a series of pipes to a point of discharge. Common points of discharge for storm sewer systems include canals, rivers, lakes, reservoirs, seas, oceans, ponds, large open areas or underground storage containers.

A catch basin functions as the inlet to many storm drain systems. The storm water enters the catch basin and the basin captures sediments and debris. The general purpose of the catch basin is to consolidate the inflows of water and to pass the water downstream via a single discharge or outflow pipe. Catch basins also help prevent down-stream pipes from becoming clogged and they assist in reducing the amount of sediment and debris being discharged from the drain system. Catch basins generally have sumps (recessed pits below the catch basin discharge or outflow pipe) that are designed to catch and hold debris that sinks to the bottom of the basin. The heavy debris that builds in the catch basin sump must be cleaned frequently as a part of regular maintenance to provide effective drainage for storm water. Proper maintenance for catch basins includes vacuum or adductor cleaning to remove accumulated solid material from the sump. Generally it is recommended that catch basin cleaning should be performed before the catch basin becomes half full.

During heavy rains or rapid snow melt, substantial amounts of water are directed into the catch basins and eventually into the main sewer lines. When the incoming flows exceed the capacity of the main sewer lines, pressurization occurs and the branch lines surcharge. In these situations, back flows can occur which can, in turn, result in residential flooding. In particular, in combined sewer systems the back flow can have potentially hazardous health consequences for the inhabitants of the flooded neighborhood.

Flow restrictors are mechanisms that are utilized to limit the peak flows entering a storm sewer system and control the release of water from the storm sewer system as a whole. Generally the flow restrictor is an orifice in the catch basin smaller than the discharge or outflow pipe. While the discharge or outflow pipe can generally range from about 12 inches to about 72 inches, a typical flow restrictor size varies from about 1 inch to about 10 inches. The flow restrictor is placed within the discharge or outflow pipe, in either a concentric or an eccentric orientation, and sealed with brick and mortar, grout or other sealing mechanism known to those of ordinary skill in the art. This orientation of the flow restrictor within the discharge or outflow pipe is depicted in prior art FIG. 2. This placement of the flow restrictor within the discharge or outflow pipe reduces the internal volume of the discharge or outflow pipe at the entrance, thus reducing the volume of water that can enter the discharge or outflow pipe. By slowing the release rate of the water flowing throughout and being released by the storm sewer system, downstream flooding risk is reduced and the release rate of the water flowing from the point of discharge is slowed.

A blockage or partial blockage of the flow restrictor from debris or refuse in the catch basin will cause a slower release rate than designed, resulting in water backup and/or flooding and potentially causing damage to homes, businesses and blocked roadways. While sumps trap debris and refuse that sinks to the bottom of a catch basin, they do nothing to eliminate the risk that floating debris will become caught in or interfere with the free flow of storm water into the flow restrictor or discharge pipe. Common floating debris includes sporting equipment and garbage in urban areas and wildlife and natural debris in suburban and more rural areas. Time and pressure dictate that as the water moves toward and through the flow restrictor so to does the debris, creating inevitable disruptions and blockages. Thus, lighter floating debris can become lodged in the flow restrictor or cover the flow restrictor completely, as demonstrated in prior art FIG. 1. Blockages of the flow restrictors disrupt water flow through the storm sewer system and result in flooding and backup which causes water damage to surrounding structures and roadways.

Due, in part, to the lack of commercially available solutions and devices designed to prevent flow restrictor and/or discharge pipe blockage, the currently utilized practice to remedy and prevent flow restrictor blockage is regular maintenance and the removal of floating refuse from catch basins. This demands that public works departments focus a large portion of their staff and resources towards the clean-up of floating refuse, diverting resources and personnel from other higher level tasks. Accordingly, there is a need in the art for a low to no-maintenance device and system that can be utilized to prevent flow restrictor blockage and improve the efficiency of water outflow, freeing public works employees to focus on higher-level responsibilities.

### SUMMARY

Because of these and other problems in the art, discussed herein is a right frustum cone shaped filtration device for a catch basin comprising: a circular base rod; a circular frustum apex rod; two or more connecting rods, each connecting rod having a first and a second terminating end; and one or more circular coaxial polygon rods; wherein the first end of each connecting rod is attached to the circular base rod and the second end of each connecting rod is attached to the circular frustum apex rod creating a right frustum cone shaped structure; and wherein the one or more circular coaxial polygon rods are attached along the length of the two or more connecting rods between the circular base and the circular frustum apex, creating a fixed frame of rods through a network of horizontal and perpendicular crossed rods to form a pattern of open spaces between crossed rods.

In one embodiment of the right frustum cone shaped filtration device for a catch basin, the lateral surface area of the filtration device is not solid.

In another embodiment of the right frustum cone shaped filtration device for a catch basin, a means for connecting the right frustum cone shaped filtration device to a structure are attached to the circular base rod.

In yet another embodiment of the right frustum cone shaped filtration device for a catch basin, the means for connecting the right frustum cone shaped filtration device to a structure comprises one or more mounting tabs attached to the circular base rod.

In another embodiment of the right frustum cone shaped filtration device for a catch basin, the one or more circular coaxial polygon rods are evenly spaced along the length of the connecting rods between the circular base rod and the circular frustum apex rod.

In another embodiment of the right frustum cone shaped filtration device for a catch basin, the one or more circular coaxial polygon rods share the same axis as both the circular frustum apex rod and the circular base rod.

In still another embodiment of the right frustum cone shaped filtration device for a catch basin, the diameters of the one or more circular coaxial polygon rods between the circular base rod and the circular frustum apex rod decrease in size from the circular base rod to the circular frustum apex rod.

In another embodiment of the right frustum cone shaped filtration device for a catch basin, the diameter of the circular base rod is four times larger than the diameter of the circular frustum apex rod.

In another embodiment of the right frustum cone shaped filtration device for a catch basin, the filtration device is comprised of metal rods. In this particular embodiment, it is contemplated that the filtration device might be hot dipped galvanized.

Also disclosed herein is a method for filtering debris for a flow restrictor, the method comprising: providing a right frustum cone shaped filtration device, the right frustum cone shaped filtration device comprising, a circular base rod; a circular frustum apex rod; two or more connecting rods, each connecting rod having a first and a second terminating end; and one or more circular coaxial polygon rods; wherein the first end of each connecting rod is attached to the circular base rod and the second end of each connecting rod is attached to the circular frustum apex rod creating a right frustum cone shaped structure; and wherein the one or more circular coaxial polygon rods are attached along the length of the two or more connecting rods between the circular base and the circular frustum apex, creating a fixed frame of rods through a network of horizontal and perpendicular crossed rods to form a pattern of open spaces between crossed rods; and attaching the base of the right frustum cone shaped filtration device to an interior surface area of a catch basin such that the flow restrictor of the catch basin is located within the circular base rod of the right frustum cone shaped filtration device.

### BRIEF DESCRIPTION OF THE DRAWINGS

FIG. 1 provides a depiction of debris build up in a catch basin of the prior art.

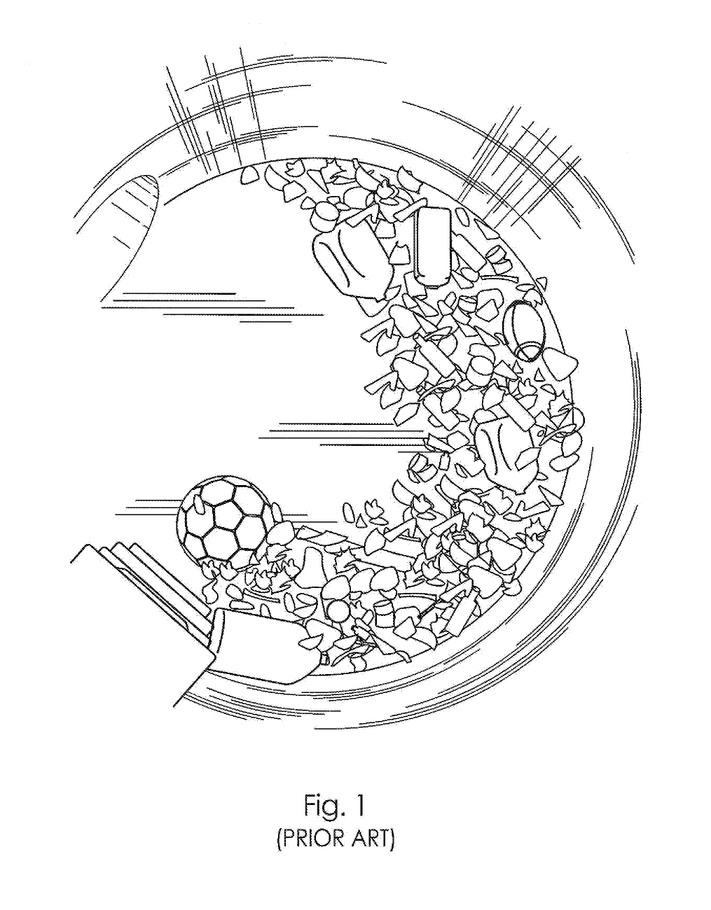

FIG. 2 provides a depiction of a restrictor pipe of the prior art, both in concentric and eccentric orientations.

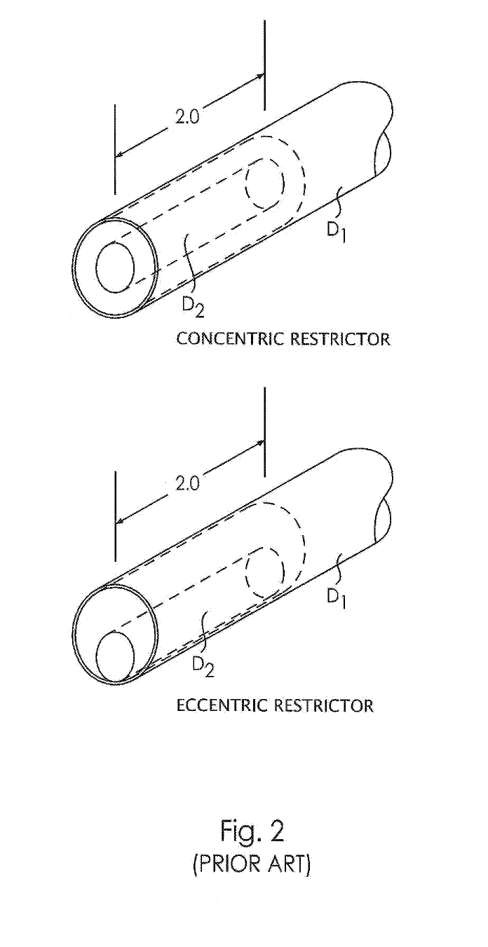

FIG. 3 provides a schematic drawing of the embodiment of the restrictor guard of FIG. 3 in which the restrictor guard has a general right circular frustum cone shaped structure.

FIG. 4 provides a perspective view of the embodiment of a restrictor guard of FIG. 3 installed over a restrictor in a catch basin.

FIG. 5 provides a perspective side view of an embodiment of the restrictor guard of FIG. 3.

FIG. 6 provides a perspective view of the embodiment of the restrictor guard of FIG. 3 from the base to the apex frustum.

### DETAILED DESCRIPTION OF PREFERRED EMBODIMENT(S)

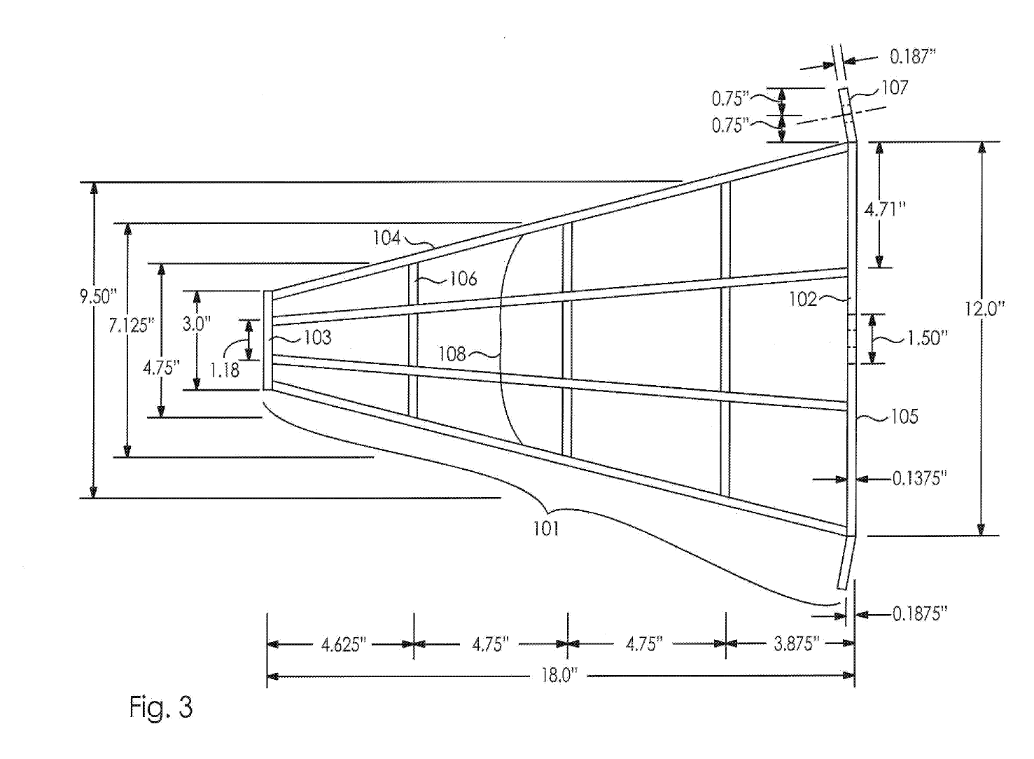

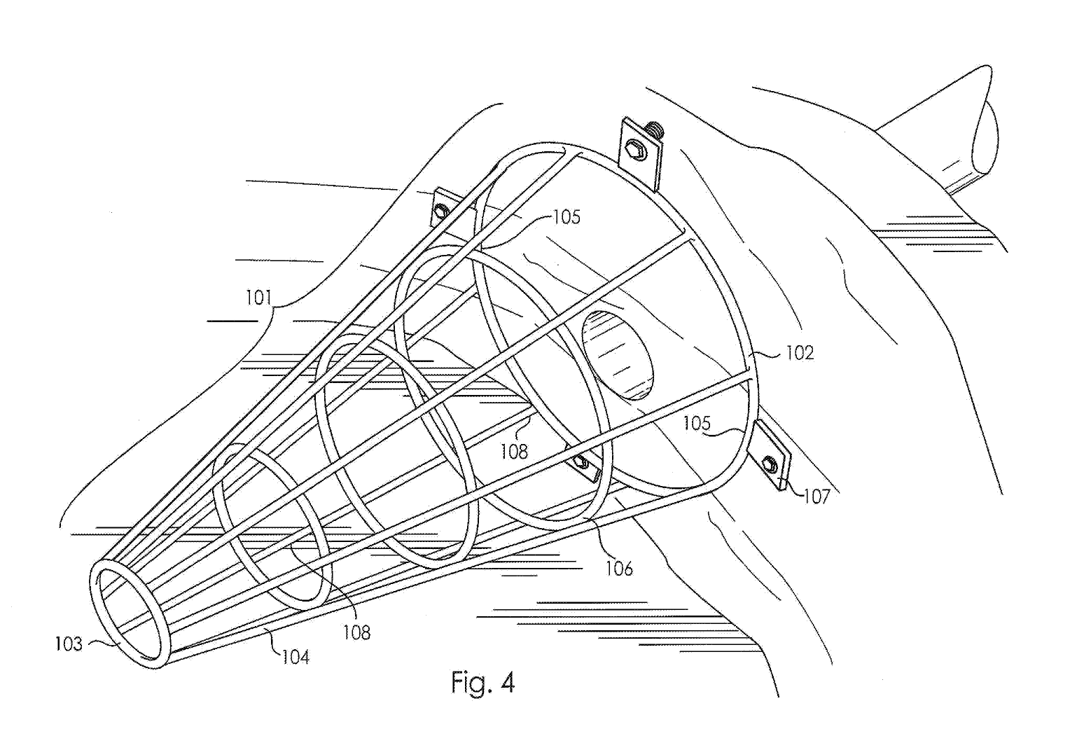

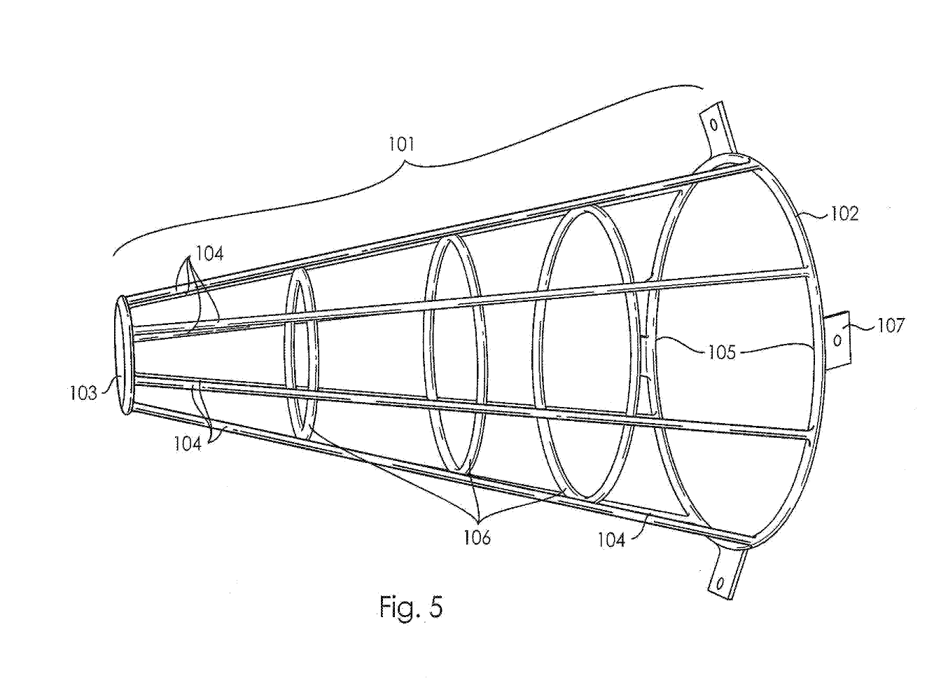

Different embodiments of the restrictor guard (101) are specifically described herein with respect to FIGS. 3-6. Generally, the device described herein is intended for use in conjunction with a catch basin in a storm water system. However it is contemplated that the restrictor guard (101) could be utilized in other applications, in industry or manufacturing, where buoyant debris needs to be filtered out of liquid solutions, in particular in areas where buoyant debris needs to be taken out of liquid solutions prior to the liquid solution entering a piping system.

In one embodiment, the restrictor guard (101) will comprise a generally right circular frustum cone shaped structure, as depicted in FIGS. 3-6. While a right circular frustum cone is depicted in FIGS. 3-6, it should be understood that other frustum conical orientations know to those of ordinary skill in the art such as oblique cones and cones with any shape base (e.g., a pyramid cone), are also contemplated general structural orientations for the restrictor guard (101). In addition, other prism and cylinder structures known to those of ordinary skill in the art are also contemplated structural orientations for the disclosed restrictor guard (101).

In the embodiment of the restrictor guard (101) depicted in FIGS. 3-6, the restrictor guard (101) consists of a base (102) and a frustum apex (103) with a length there-between. The restrictor guard (101) is a generally rod-based structure. Stated differently, the base surface (105), lateral surface (108) and other surface areas of the restrictor guard (101) are not solid. Rather, the base surface (105), lateral surface (108) and other surface areas of the restrictor guard (101) are comprised of various orientations of rods, wires, bars, and/or strips of material placed to create a fixed frame of rods in a network of horizontal and perpendicular crossed lines to form a pattern of open spaces between crossed rods.

Thus, the general conical structure of the restrictor guard (101) depicted in FIGS. 3-6 is generally comprised of rods, wires, bars, and/or strips of material orientated into a grating with a general frustum conical structure. It is contemplated that metal, plastics, fiber, or other flexible/ductile material will comprise the rods, wires, bars and/or strips of the restrictor guard (101). While rods, wires, bars, and/or strips of material are all contemplated for use in the restrictor guard (101) of this application, the term “rod” will be utilized to collectively represent these structures in this disclosure.

The width or diameter of the rods of the restrictor guard (101) is not determinative. Any diameter rod is contemplated so long as it can be oriented to create a fixed frame of rods in a network of horizontal and perpendicular crossed lines while having a pattern of open spaces between the crossed rods that allows for the free-flow of water there-through. Contemplated widths for the rods which comprise the restrictor guard (101) include, but are not limited to, ¼ inch, ½ inch, ⅓ inch, ⅛ inch, ⅜ inch, 3/16 inch and/or other widths known to those of ordinary skill in the art.

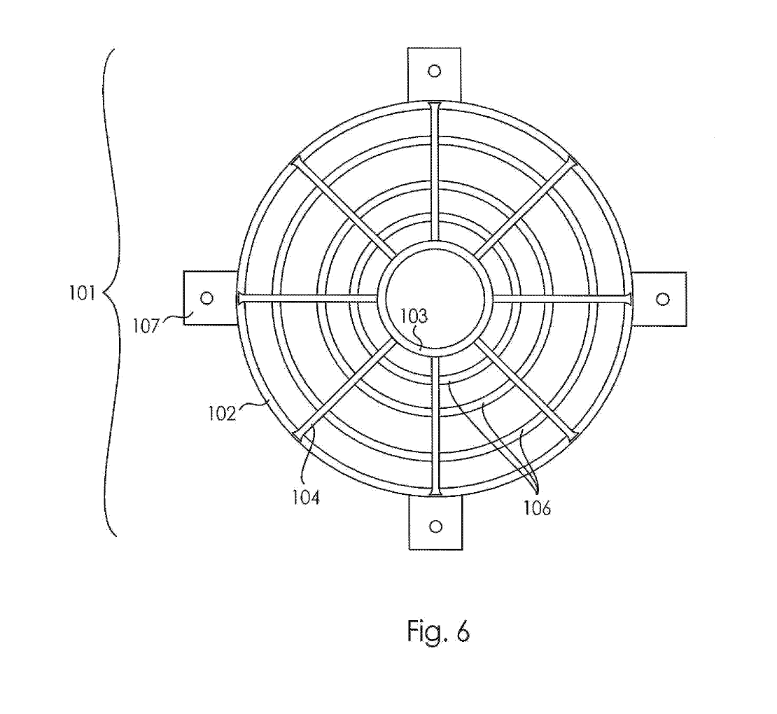

In one embodiment, the base (102) of the restrictor guard (101) is a circle, as depicted in FIG. 6. In other embodiments the base (102) of the restrictor guard (101) will be a polygonal figure known to those of ordinary skill in the art. The base (102) is created by a rod outlining the perimeter or circumference of a circular or polygonal base (102). FIGS. 3-6 demonstrate alternative views of the base (102) of the restrictor guard in an embodiment in which the base (102) is a circle.

As demonstrated in FIG. 6, attached to the base (102) of the restrictor guard (101) is a means for connecting the restrictor guard (101) to a catch basin or other structure. In one embodiment, as depicted in FIGS. 3-6, the means for attachment are one or more mounting tabs (107). In one embodiment, as depicted in FIG. 6, four mounting tabs (107) will be attached to the base (102) of the restrictor guard (101). These tabs (107) function to attach the restrictor guard (101) to a structure such as a catch basin when utilized with a screw, nail or other hard metal or alloy fastener. Other contemplated means of attachment for the restrictor guard (101) include, but are not limited to, hook and loop closures, battens, brass fasteners, buckles, buttons, captive fasteners, clamps (or cramps), clasps, cleko, clip, flange, grommet, masonry anchor, nail, peg, pin, rivet, screw anchor, snap, staple, strap, tack, threaded fastener, and other suitable fasteners or fastening systems known to those of ordinary skill in the art. Generally, any mechanism that allows for attachment of the base (102) of the restrictor guard (101) to a structure in such a manner that the restrictor guard (101) can facilitate the filtering of a liquid, whether the means of attachment is permanent or temporary, is contemplated in this disclosure.

Generally the diameter of the base (102) of the restrictor guard (101) will be larger than the diameter of the flow restrictor or the discharge pipe over which the restrictor guard (101) is placed. For example, if the flow restrictor has a diameter of about 10 inches, the base (102) of the restrictor guard (101) will have a diameter of more than 10 inches. If the flow restrictor has a diameter of about 1 inch, the base (102) of the restrictor guard (101) will have a diameter of more than 1 inch. For example, in one embodiment, as depicted in FIG. 3, a restrictor guard (101) with a diameter of about 12 inches will be placed over a flow restrictor with a diameter of about 1.5 inches (i.e., the diameter of the base of the restrictor guard (101) will be about eight (8) times the size of the diameter of the flow restrictor it is protecting).

Also attached to the base (102) are two (2) or more connecting rods (104). The width or diameter of the connecting rods (104) is not determinative, any diameter rod is contemplated so long as it can be oriented to create a fixed frame of rods in a network of horizontal and perpendicular crossed lines while having a pattern of open spaces between the crossed rods that allows for the free-flow of water there through. Contemplated widths for the connecting rods (104) include, but are not limited to, ¼ inch, ½ inch, ⅓ inch, ⅛ inch, ⅜ inch, 3/16 inch and/or other widths known to those of ordinary skill in the art. In one embodiment, the connecting rods (104) will be a smaller width than the width of the rods that comprise the base (102) of the restrictor guard (101). In another embodiment, the width of the connecting rods (104) will be the same as the width of the rods that comprise the base (102) of the restrictor guard (101). Still, in another embodiment, the width of the connecting rods (104) will be larger than the rods that comprise the base (102) of the restrictor guard (101). Furthermore, in one embodiment the width of each of the two or more connecting rods (104) will be the same. In another embodiment, the width of each of the two or more connecting rods (104) will vary from one to the other.

One of the terminating ends of each of the connecting rods (104) will be attached to the base (102) of the restrictor guard (101) by welding, melting, soldering, brazing or other means known to those of ordinary skill in the art for forming a bond between two pieces of metal, metal alloys, plastic, fiber or other material utilized for the rods of the restrictor guard (101). The connecting rods (104) will extend from the terminating end attached to the base (102) to a terminating end attached to the frustum apex (103) of the restrictor guard (101), as depicted in FIG. 3. The terminating end of the connecting rod (104) attached to the frustum apex (103) of the restrictor guard (101) will also be attached by welding, melting, soldering, brazing or other means known to those of ordinary skill in the art. Accordingly, each of the two or more connecting rods (104) will comprise straight line segments joining the frustum apex (103) to the perimeter of the base (102) of the restrictor guard (101). In embodiments of the restrictor guard (101) where the frustum apex (103) is smaller in dimension then the base (102), the connecting rods (104) will angle toward the axis of the restrictor guard (101) along their length from the base (102) to the apex frustum (103), creating a gradually descending plane as depicted in FIGS. 3-5. In embodiments of the restrictor guard (101) in which the base (102) has the same dimensions as the frustum apex (103) the connecting rods (104) will connect the base (102) and the frustum apex (103) via a plane generally perpendicular to both the base (102) and the frustum apex (103).

Along the length of the connecting rods (104) are located one or more coaxial polygons (106) to the base (102) and the frustum apex (103). In general, the one or more coaxial polygons (106) will take the same shape as the base (102) of the restrictor guard (101). Stated differently, contemplated shapes for the one or more coaxial polygons (106) include circles, squares, and polygonal figures known to those of ordinary skill in the art. When the base (102) is a circular shape, the one or more coaxial polygons (106) will be a circular shape. In contrast, when the base (102) is another polygonal shape, the one or more coaxial polygons will take on that other polygonal shape.

Each of the one or more coaxial polygons (106) is oriented in a manner that is perpendicular to the connecting rods (104) and parallel to both the base (102) and the frustum apex (103), as depicted in FIGS. 3-6. Each of the one or more coaxial polygons (106) will be attached to each of the one or more connecting rods (104) of the restrictor guard (101) by welding, melting, soldering, brazing or other means known to those of ordinary skill in the art for forming a bond between two pieces of metal, metal alloys, plastic, fiber or other material utilized for the rods of the restrictor guard (101). In one embodiment as depicted in FIGS. 3-5, the connecting rods (104) slope downwards from the base (102) to the smaller apex frustum (103). In this embodiment, the connecting rods (104) will attach to the one or more coaxial polygons (106) at varying angles of intersection. In other embodiments in which the base (102) and the apex frustum (103) have the same dimensions, the intersections between the one or more coaxial polygons (106) and the connecting rods (104) will generally be at right angles.

In each orientation, the intersection between the one or more coaxial polygons (106) and the connecting rods (104) creates a grid-like structure for the lateral surface area (108) of the restrictor guard (101). The size of the individual grids of this grid-like structure or grating created by the perpendicular and horizontal orientation and intersection of the connecting bars (104), coaxial polygons (106), base (102) and frustum apex (103) of the restrictor guard (101) is not determinative. Generally any size grid that is able to restrict, filter or block floating debris that could clog or impair the flow restrictor or discharge pipe is contemplated. Dimensions of individual grids which would allow not just water but also floating debris of a certain size that could clog the flow restrictor into the interior of the flow restrictor are not contemplated. Similarly, so long as each individual grid of the restrictor guard (101) can effectively block debris while letting liquid into the interior of the restrictor guard (101), the individual grids of the restrictor guard (101) grating can be either the same size or different sizes. In general, in some embodiments, the size of the grid will be such that more liquid will be allowed to flow into the interior of the restrictor guard (101) than can enter the flow restrictor or discharge pipe. The restrictor guard (101) does not limit the flow of water into its interior, it only restricts/limits floating debris of a certain surface area which could clog the flow restrictor from floating into its interior surface area thereby protecting the flow restrictor from clogging.

Generally the one or more coaxial polygons (106) of the restrictor guard (101) will be evenly spaced along the length of the connecting rods (104), as depicted in FIGS. 3-6, however this spacing is not determinative. Any spacing of the coaxial polygons (106) along the length of the connecting rods (104) that creates an overall grid-like structure on the lateral surface area (108) of the restrictor guard (101) is contemplated in this application. For example, in one embodiment the distance between a first coaxial polygon (106) and the base (102) will be shorter than the distance between a second coaxial polygon (106) and the first coaxial polygon (106).

Each of the one or more coaxial polygons (106), located from the base (102) to the apex frustum (103), will share the same axis as both the base (102) and the apex frustum (103), as seen in FIGS. 3-6. Further, in one embodiment, each of the one or more coaxial polygons (106) will gradually decrease in size from the base (102) to the frustum apex (103). In the embodiment in which the restrictor guard (101) has a general right conical frustum structure, the circle at the base (102) will have the largest radius and the circle at the frustum apex (103) will have the smallest radius. In this embodiment, the radii of the coaxial polygons (106) connected along the length of the connecting rods (104) from the base (102) to the frustum apex (103) decrease from the base (102) to the frustum apex (103) and, conversely, increase from the frustum apex (103) to the base (102).

For example, as depicted in FIG. 3, the restrictor guard (101) will be comprised of a base (102), a frustum apex (103) and three coaxial polygons (106) spaced along the length of the connecting rods (106) from the base (102) to the frustum apex (103). In this embodiment, the base (102) will have about a 12 inch diameter, the first coaxial polygon will have about a 9.5 inch diameter, the second coaxial polygon will have about a 7.125 inch diameter, the third coaxial polygon will have about a 4.75 inch diameter and the frustum apex (103) will have about a 3 inch diameter. Thus, in this particular embodiment, the diameter of the frustum apex (103) is four times smaller than the diameter of the base (102). However it should be noted that this decrease in the size of the coaxial polygons (106) from the base (102) to the frustum apex (103), while depicted in the FIGS., is not determinative. In alternative embodiments it is contemplated that the restrictor guard (101) will have a general cylinder or other prism shape in which the base (102) and the frustum apex (103) and each of the one or more coaxial polygons (106) along the length of the connecting rods (104) will have the same dimensions.

The radius of the frustum apex (103) will generally be the same or greater than the radius of the restrictor or intake pipe over which the restrictor guard (101) is placed. For example, as depicted in FIG. 3, the radius of the frustum apex (103) is about 3 inches and the radius of the restrictor is about 1.5 inches. While these exact measurements are not determinative, it is contemplated that the frustum apex (103) will have a larger surface area than the surface area of the restrictor or intake pipe over which the restrictor guard (101) is placed.

The length of the connecting rods (104) from the base (102) to the frustum apex (102) creates a general lateral surface area (108) for the restrictor guard (101). As demonstrated in FIGS. 3-5, the lateral surface area (108) of the restrictor guard (101) is not solid. Rather, the lateral surface area (108) of the restrictor guard (101) generally comprises a cage-like structure or a grating; i.e., a regularly spaced collection of elements. In one embodiment each element which comprises the grating of the lateral surface area (108) of the restrictor guard (101) may be the same size. In another embodiment, as depicted in FIGS. 3-5, each element which comprised the grating of the lateral surface area (108) of the restrictor guard (101) is different in size. Generally, any orientation of each of the respective grids of the lateral surface area (108) of the restrictor guard (101) which allows for the free flow of fluid through the restrictor guard (101) is contemplated in this disclosure. Stated differently, each element which comprises the grating of the lateral surface area of the restrictor guard (101) can be larger, smaller or about the same size as the surface area of the flow restrictor so long as it is sufficiently sized to catch floating object and debris which could potentially block the flow restrictor.

In one embodiment of the restrictor guard (101), the restrictor guard (101) will be hot dipped galvanized to prevent corrosion. It is also contemplated that films or other coatings known to those of ordinary skill in the art for the prevention of corrosion are also contemplated finishing methods for the restrictor guard (101).

Generally, when attached to a catch basin the restrictor guard (101) will be attached over the flow restrictor and, as such, placed in a general horizontal orientation as depicted in FIGS. 3-5. However, this orientation is not determinative as any orientation which allows for the restrictor guard (101) to cover the flow restrictor is contemplated. Further, it is contemplated that when in use part of the restrictor guard (101), from time-to-time, will be under water.

One specific embodiment of the restrictor guard (101) is depicted in FIG. 3. In this embodiment, the restrictor guard (101) is a right circular frustum cone structure. The restrictor guard (101) of this embodiment is comprised of a circular base (102), a circular apex frustum (103), 3 circular coaxial polygons (106) of decreasing size positioned from the base (102) to the apex frustum (103) and 8 connecting rods (104) connecting the circular base (102), circular apex frustum (103) and 3 circular coaxial polygons (106) to create an overall right circular frustum structure. The circular base (102) of the restrictor guard of FIG. 3 is comprised of about ⅜ inch cold round stock and has a diameter of about 12 inches. Four mounting tabs (107) are attached to the circumference of the base (102), equally spaced from each other at the twelve, three, six and nine o'clock orientations. Each of the 4 mounting tabs (107) are about 3/16 inch thick and are about 1.5×1.5 inches square with a about 5/16 inch hole drilled in the center. Each of the 8 connecting rods (104) is about 18 inches long. The 3 circular coaxial polygons are placed along the length of the connecting rods (104). The first of the circular coaxial polygons is about 9.50 inches in diameter and about 3.875 inches from the base (102). The second of the circular coaxial polygons is about 7.125 inches in diameter and about 4.75 inches from the first circular coaxial polygon. The third of the circular coaxial polygons is about 4.75 inches in diameter and about 4.75 inches from the second circular coaxial polygon. Finally, the apex frustum (103) is about 3.0 inches in diameter and about 4.625 inches from the third of the circular coaxial polygons. The 3 circular coaxial polygons (106), the apex frustum (103) and the 8 connecting rods (104) are all comprised of about 5/16^{th} inch cold roll round stock. Further, each of the points of attachment in this embodiment of the restrictor guard (101) are welded joints.

As is demonstrated in the diagram, the lateral surface area (108) of the restrictor guard (101) of this embodiment is a general grid-like structure—the base (102), apex (103), connecting rods (104) and coaxial polygons (106) form an overall structure that allows for the free flow of water through the restrictor when buoyant debris enters the catch basin. The general cone shaped design of the restrictor guard (101) in this embodiment helps to concentrate floating debris to one side of the restrictor guard (101), leaving the other side open for water to flow through the restrictor. This general cone shaped design helps to push debris away from the front of the restrictor and limits the possibility of blockages due to water pressure pushing debris towards the restrictor. In general in this and other embodiments, the restrictor guard's (101) screen size is designed to allow water to flow to the restrictor without changing the designed release rate of the restrictor. Thus, the restrictor guard (101) provides 360 degree protection for the restrictor to respond to the variance in water levels, pressure and debris build-up.

In one case study in which the restrictor guard (101) was implemented, the restrictor guard (101) was installed at a site where animal life had repeatedly caused total blockage of the restrictor (101), resulting in a rise in the water level of the retaining pond. After the restrictor guard (101) was installed, the restrictor remained unobstructed. Further, in another case study, the restrictor guard (101) was installed in an urban environment where, during storm events, homeowners had reported excessive water levels that failed to recede. Items including sporting equipment, yard debris, and everyday trash had caused partial or total blockage of the restrictor. After installation of the restrictor guard (101), there where no further reports of flooding.

In sum, the restrictor guard (101) offers a low to no-maintenance solution to improve the efficacy of water outflow, allowing public works departments to focus on higher-level responsibilities. Further, the restrictor guard (101) can be easily installed in any catch basin. Thus the restrictor guard (101) either reduces or eliminates many of the liabilities associated with exposed restrictors including but not limited to: property damage, consumed labor hours in unnecessary site maintenance and blockage prevention before incidents occur.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A right frustum cone shaped filtration device for a catch basin comprising:
a circular base rod;
a circular frustum apex rod;
two or more connecting rods, each connecting rod having a first and a second terminating end; and
one or more circular coaxial polygon rods;
wherein the first end of each connecting rod is attached to the circular base rod and the second end of each connecting rod is attached to the circular frustum apex rod creating a right frustum cone shaped structure; and
wherein the one or more circular coaxial polygon rods are attached along the length of the two or more connecting rods between the circular base and the circular frustum apex, creating a fixed frame of rods through a network of horizontal and perpendicular crossed rods to form a pattern of open spaces between crossed rods.

2. The right frustum cone shaped filtration device for a catch basin of claim 1 wherein the lateral surface area of the filtration device is not solid.

3. The right frustum cone shaped filtration device for a catch basin of claim 1 wherein a means for connecting the right frustum cone shaped filtration device to a structure are attached to the circular base rod.

4. The right frustum cone shaped filtration device for a catch basin of claim 3 wherein the means for connecting the right frustum cone shaped filtration device to a structure comprises one or more mounting tabs attached to the circular base rod.

5. The right frustum cone shaped filtration device for a catch basin of claim 1 wherein the one or more circular coaxial polygon rods are evenly spaced along the length of the connecting rods between the circular base rod and the circular frustum apex rod.

6. The right frustum cone shaped filtration device for a catch basin of claim 1 wherein the one or more circular coaxial polygon rods share the same axis as both the circular frustum apex rod and the circular base rod.

7. The right frustum cone shaped filtration device for a catch basin of claim 1 wherein the diameters of the one or more circular coaxial polygon rods between the circular base rod and the circular frustum apex rod decrease in size from the circular base rod to the circular frustum apex rod.

8. The right frustum cone shaped filtration device for a catch basin of claim 1 wherein the diameter of the circular base rod is four times larger than the diameter of the circular frustum apex rod.

9. The right frustum cone shaped filtration device for a catch basin of claim 1 wherein the filtration device is comprised of metal rods.

10. The right frustum cone shaped filtration device for a catch basin of claim 9 wherein the filtration device is comprised of hot dipped galvanized.

11. A method for filtering debris for a flow restrictor, the method comprising:
providing a right frustum cone shaped filtration device, the right frustum cone shaped filtration device comprising,
a circular base rod;
a circular frustum apex rod;
two or more connecting rods, each connecting rod having a first and a second terminating end; and
one or more circular coaxial polygon rods;
wherein the first end of each connecting rod is attached to the circular base rod and the second end of each connecting rod is attached to the circular frustum apex rod creating a right frustum cone shaped structure; and
wherein the one or more circular coaxial polygon rods are attached along the length of the two or more connecting rods between the circular base and the circular frustum apex, creating a fixed frame of rods through a network of horizontal and
perpendicular crossed rods to form a pattern of open spaces between crossed rods; and attaching the base of the right frustum cone shaped filtration device to an interior surface area of a catch basin such that the flow restrictor of the catch basin is located within the circular base rod of the right frustum cone shaped filtration device.
